(19) United States
(12) Patent Application Publication
(10) Pub. No.: US 2013/0195032 A1
(43) Pub. Date: Aug. 1, 2013

(54) Apparatus and Method Relating to a Power Quotient Used in a Telecommunications System

(71) Applicants: Bo Göransson, Sollentuna (SE); Håkan Andersson, Linkoping (SE); Tomas Sundin, Sollentuna (SE)

(72) Inventors: Bo Göransson, Sollentuna (SE); Håkan Andersson, Linkoping (SE); Tomas Sundin, Sollentuna (SE)

(73) Assignee: TELEFONAKTIEBOLAGET LM ERICSSON (PUBL), Stockholm (SE)

(21) Appl. No.: 13/637,592

(22) PCT Filed: Aug. 27, 2012
(86) PCT No.: PCT/SE2012/050903

§ 371 Date: Sep. 26, 2012

Related U.S. Application Data
(60) Provisional application No. 61/592,902, filed on Jan. 31, 2012.

(51) Int. Cl. H04W 52/04; H04W 72/04

(52) U.S. Cl. 370/329

(57) ABSTRACT

There is provided a method for implicitly signaling a power quotient to a user equipment, the power quotient providing a relationship between a reference signal and a data signal. The method comprises the steps of receiving a downlink control signal from a radio base station, the downlink control signal containing an index signal that is provided for indicating a modulation and/or coding scheme being used by the radio base station, and using the index signal to determine a power quotient that is to be used by the user equipment.

### TECHNICAL FIELD

The present invention is concerned with an apparatus and method relating to a power quotient used in a telecommunications network, and in particular to an apparatus and method for implicitly signaling a power quotient between a radio base station and a user equipment.

### BACKGROUND

In recent years a large deployment of telecommunication systems for different standards has been realized, to a large extent, by placing radio base stations (RBS) in cellular networks covering large areas. FIG. 1 shows such a telecommunications system in which cells 101a, 101b and 101c are served by respective RBSs 103a, 103b and 103c, for communicating with User Equipment (UE) devices 105. As the demand for capacity and coverage increases, more and more nodes or RBSs are deployed.

More recent technologies utilize higher and higher frequencies, which tend to experience increasing pathloss with increasing frequency. In addition, deployment of cellular systems in urban areas suffer from difficult propagation conditions, for example caused by buildings and other structures that interfere with the propagation of the telecommunication signals. As a result of these factors, RBSs tend to be deployed in ever-tighter configurations, typically with varying output power, so-called heterogeneous network (HetNet) deployments.

The output power of the RBS is an important parameter during the cell planning of the network. RBS placement and output power should give enough coverage on downlink (DL) transmissions in the entire cell but without wasting power or interfering with neighboring cells.

In order to enable coherent detection of the downlink in the UE, the RBS transmits reference signals (RS), also known as pilot signals. These are pre-defined signals of known amplitude and phase, transmitted at well-defined instances in the time/frequency or code domain. The UE uses the pilot signals to estimate the instantaneous channel conditions.

Typically, the RBS transmits a pilot signal that is unique (within a large geographical area) to the cell. There is also a higher-level signaling mechanism that informs a UE of the power quotient between the pilot signal and the data. Together with the channel estimate, this power quotient enables the UE to decode the data efficiently.

In more recent evolvements of the mobile network standards, UE-specific pilot symbols, known as DeModulation Reference Symbols (DMRS) or dedicated pilot signals are used. A DMRS is unique to a specific UE and only transmitted together with data to that particular UE. The advantages of DMRS over the more conventional cell specific pilot signals are several. They need only be transmitted when there is data transmission ongoing (i.e. rather than continual periodic transmission), which saves energy and minimizes interference. They can also be subjected to the same precoding (for example beam forming) as the data being transmitted to the UE.

Another advantage with DMRS is that the power level of the dedicated pilot signals can be set per user. Further information about dedicated pilot signals can be seen in the technical specifications of the 3rd Generation Partnership Project (3GPP), and in particular the technical specification 3GPP TS series 36 (Release 8) relating to the LTE standard. For the High-Speed Downlink Packet Access standard, HSDPA, further details about dedicated pilot signals can be seen in the technical specification 3GPP TS series 25 (Release 5).

The problem with the existing situation is that there is a very rudimentary power control on the downlink. Some higher-level signaling will inform the UE of the power quotient between the pilot signal and the data, which is the same throughout the cell. The value of the power quotient changes seldom since it is usually a result of cell planning.

With the advent of UE-specific DMRS the power quotient between the power of the DMRS and the data for that particular UE can be adapted independently of other UEs. With per-UE-based power adaptation, which is feasible with the use of DMRS, the need to signal this power quotient per UE is desirable. It is also desirable to signal this parameter very often, preferably every Transmission Time Interval (TTI), since the output power of the RBS can be expected to be varied per TTI. Existing mobile network standards do not provide such a mechanism for communicating a power quotient to the UE.

One solution is to explicitly transmit the power quotient to each UE. This has the disadvantage of increasing network traffic, particularly if the power quotient is transmitted every TTI.

Another solution is for the UE to estimate the power quotient, thereby avoiding signaling traffic. However, this solution is not an attractive option since it requires a large amount of processing power in the UE, which could potentially be used for other tasks. Estimating the power quotient also has the disadvantage of giving an unknown, residual error which adversely affects the quality of the subsequent channel estimation.

### SUMMARY

It is an aim of the present invention to provide a method and apparatus which obviate or reduce at least one or more of the disadvantages mentioned above.

According to a first aspect of the invention there is provided a method in a user equipment of a telecommunications system, for determining a power quotient that is to be used by the user equipment, the power quotient providing a relationship between a reference signal and a data signal. The method comprises the steps of receiving a downlink control signal from a radio base station, the downlink control signal containing an index signal that is provided for indicating a modulation and/or coding scheme being used by the radio base station, and using the index signal to determine a power quotient that is to be used by the user equipment.

According to another aspect of the invention there is provided a user equipment for use in a telecommunications system. The user equipment comprises a receiving unit adapted to receive a downlink control signal from a radio base station, and a processing unit adapted to extract an index signal contained in the downlink control signal, the index signal relating to a coding and/or modulation scheme being used by the radio base station. The processing unit is adapted to configure the user equipment according to the coding and/or modulation scheme indexed by the index signal. The processing unit is further adapted to determine a power quotient using the index signal, and configure the user equipment using the determined power quotient.

According to another aspect of the invention there is provided a method in a radio base station of a telecommunications system. The method comprises the steps of setting a power of a data signal and a power of a reference signal according to a power quotient, and transmitting an index signal to a user equipment in a downlink control signal, wherein the index signal is provided for indicating a modulation and/or coding scheme being used by the radio base station, and implicitly signaling the power quotient to the user equipment using the index signal.

### BRIEF DESCRIPTION OF THE DRAWINGS

For a better understanding of the present invention, and to show more clearly how it may be carried into effect, reference will now be made, by way of example only, to the following drawings in which:

FIG. 1 shows a typical telecommunications system;

FIG. 2 shows a known modulation/coding scheme table for use in a telecommunications system;

FIG. 3a shows an example of a modulation/coding scheme table for use with embodiments of the present invention;

FIG. 3b shows an example of another table for use with embodiments of the present invention;

FIG. 4 shows the steps performed by a user equipment, according to an embodiment of the present invention;

FIG. 5 shows a user equipment according to an embodiment of the present invention;

FIG. 6 shows the steps performed by a radio base station of a telecommunications system, according to an embodiment of the present invention;

FIG. 7a shows a table relating to the Long-Term Evolution, LTE, standard;

FIG. 7b shows an example of a modified table according to an embodiment of the present invention, when used with the LTE standard;

FIG. 8a shows a table relating to the High-Speed Downlink Packet Access, HSDPA, standard; and

FIG. 8b shows an example of a modified table according to an embodiment of the present invention, when used with the HSDPA.

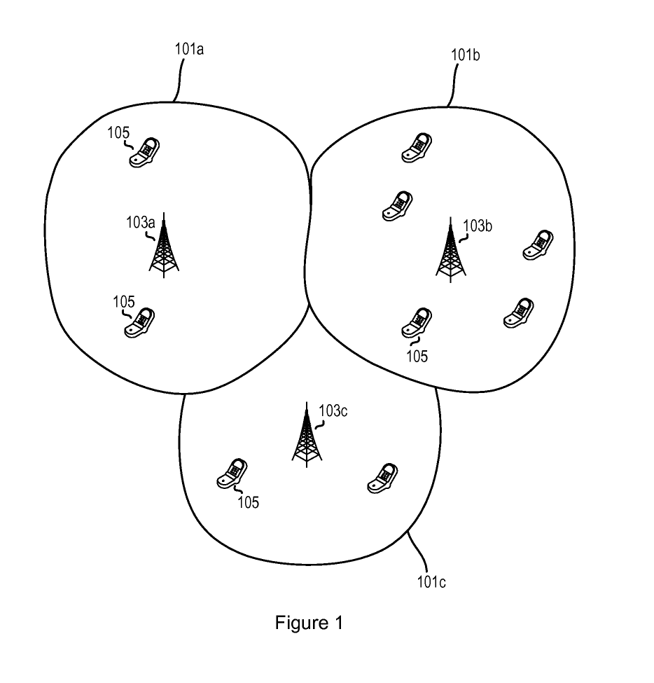

### DETAILED DESCRIPTION

The embodiments of the invention will be described below in relation to applications relating to various standards, including the Long-Term Evolution (LTE) standard and the High-Speed Downlink Packet Access (HSDPA) standard. It is noted, however, that the embodiments of the invention may be used with other standards in which some form of power quotient is to be utilised by a user equipment.

As mentioned earlier, an advantage with DeModulation Reference Symbols (DMRS) is that the power level of such reference signals can be set per user equipment (UE), thereby acting as dedicated pilot signals. The quality of a channel estimate is dependent on the amount of energy present in the DMRS. For example, a higher-order modulation such as 64 QAM is more sensitive to channel estimation error than, for example, QPSK-modulated data. Hence, it is beneficial to be able to allocate a DMRS power level that depends on the modulation order. Similarly, a lower DMRS power can be allocated when the coding rate is lower since the information rate is lower for such transmissions. Since each user experiences different channel quality, the DMRS power level is preferably user specific, for example for each scheduled data block.

The embodiments of the invention consist of providing a mechanism for signaling the power quotient for individual UEs in an implicit manner, without the need to introduce additional parameters in existing standards for explicit signaling, and in particular without introducing additional signaling between the radio base station (RBS) and UE. In other words, the embodiments of the invention enable a UE to determine which power quotient it should use from implicit signaling in the downlink transmission, without any explicit signaling from a RBS.

The embodiments of the invention therefore have the advantage of enabling the power quotient of a UE to be conveyed to the UE without any additional explicit signaling, thereby reducing network traffic.

The embodiments of the invention also have the advantage in that they offer a solution that is backwards compatible with existing equipment.

Furthermore, as will be described in greater detail below, the embodiments of the invention enable the power quotient for a UE to be implicitly signaled on a per-TTI-basis (i.e. per Transmission Time Interval).

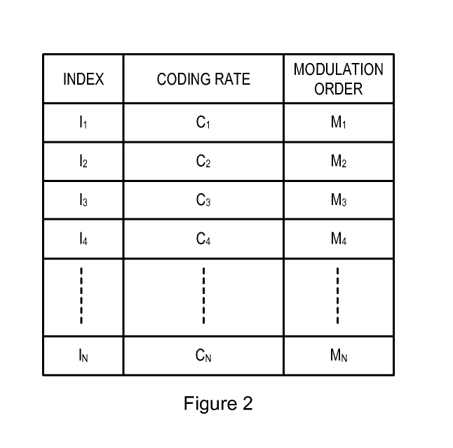

FIG. 2 shows a known table illustrating a modulation and coding scheme (MCS) used by a radio base station when communicating with a user equipment. The table of FIG. 2 comprises different coding rates C₁ to C_{N} and modulation orders M₁ to M_{N} for a particular telecommunications standard. Index signals I₁ to I_{N} are used to map or point to a particular combination of coding rate and/or modulation order. For example, index signal I₃ points to coding rate C₃ and modulation order M₃. An index signal is sent from a RBS to a UE in a downlink control channel, for example a downlink scheduling message. Thus, in a conventional telecommunications system, a downlink scheduling message from a RBS to a UE will include an index signal that informs a particular UE what coding rate and/or modulation order is being used in the downlink transmission. For example, if the RBS transmits index signal I₄, the UE can determine that the coding rate is C₄ and the modulation order is M₄ for that particular transmission. The index signal is typically transmitted in each TTI, such that the UE can adapt the coding rate and/or modulation order per TTI.

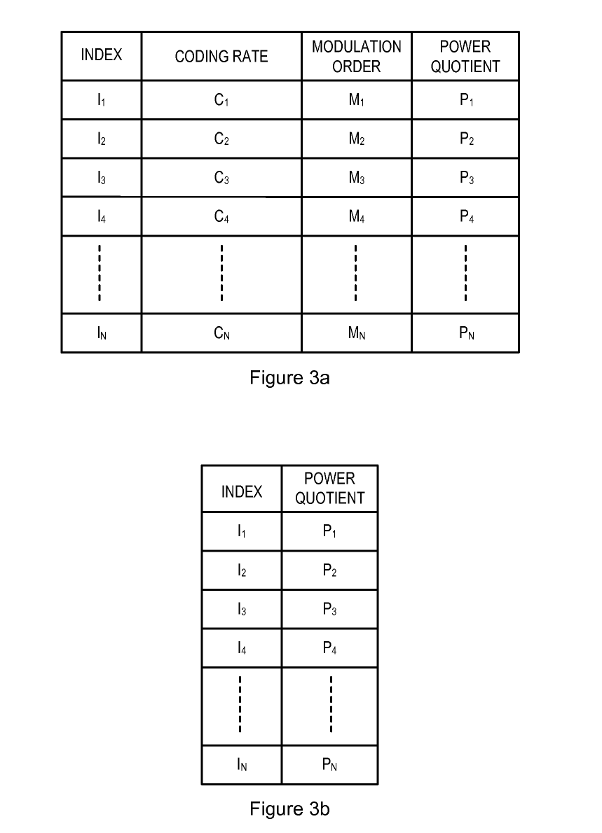

FIG. 3a shows a modified table for use with embodiments of the present invention. As with FIG. 2, the table comprises different coding rates C₁ to C_{N} and modulation orders M₁ to M_{N}. Index signals I₁ to I_{N} are used to map or point to a particular combination of coding rate and/or modulation order. For example, index signal I₃ points to coding rate C₃ and modulation order M₃. According to this embodiment of the invention, the table comprises an additional column comprising power quotients P₁ to P_{N} that are to be used with respective coding rates C₁ to C_{N} and/or modulation orders M₁ to M_{N}, which in turn are referenced by index signals I₁ to I_{N}.

Thus, in a downlink control signal, such as a scheduling message, as before a RBS will simply include an index signal that informs a particular UE what coding rate and/or modulation order is being used. For example, if the RBS transmits index signal I₄, the UE can determine that the coding rate is C₄ and/or that the modulation order is M₄ for that particular transmission. However, according to embodiments of the invention, a UE is able to also determine the power quotient that is to be used, by using the index signal “I” to implicitly infer the power quotient signaled by the RBS.

The index signal may be transmitted in each TTI, such that the UE can also adapt the power quotient per TTI, in addition to adapting the coding rate and/or modulation order per TTI.

Each row may comprise different power quotients, coding rates and/or modulation orders. It is noted, however, that the embodiments of the invention also embrace situations in which two or more different rows have the same coding rate but different modulation orders, or vice versa, or whereby two or more rows have the same power quotient.

Although FIG. 3a shows the list of available power quotients forming part of the same table as the modulation and/or coding scheme table being used by the telecommunications system, it is noted that the power quotients may be provided in a separate table as shown in FIG. 3b, but which is still indexed by the index signal “I” shown in FIG. 3a, that is the index used to map or point to the modulation and/or coding scheme. It is noted that the power quotients may also form part of some other table (not shown), which is indexed by the index signal “I” normally used for indexing the modulation and/or coding scheme being used.

Furthermore, it is noted that different standards may comprise different tables where the power quotient values may reside, as will be explained later in the application. Alternatively, a single table may be provided, with multiple different columns relating to the power quotient applicable to different standards. According to one embodiment a RBS or other part of the network can configure which column is to be used in such tables having multiple power quotient columns.

Also, as will be explained later in the application, a table may be configured such that part of the table is provided in one area or part of a standard, and another part of the table in a different area or part of the standard, with the index signal either pointing directly to respective rows in such table or tables, or indirectly via some other intermediary signal or index.

From FIGS. 3a and 3b above it can be seen that the inventors have realised that the preferred power quotient of a UE is approximately based on a signal-to-noise ratio of the downlink channel, which in turn is related to the coding and/or modulation schemes used by a RBS for that UE. For example, the signal-to-noise ratio may be approximately proportional to the coding and/or modulation schemes used by a RBS for a UE.

Therefore, the RBS can send an index signal in the downlink control signal, which points to a table relating to the coding and/or modulation scheme being used, but whereby the index signal also points to a row in a table which contains the power quotient that is best suited for that coding/modulation set-up. The extra column can be devised at a set-up phase. Alternatively, the power quotient can be dynamically changed during use, if required. For example the power quotients may be dynamically changed during use in response to network changes that may affect the preferred power quotients to be used for each modulation/coding scheme. For example, in HSDPA there are provided L1/L2 orders (HS-SCCH orders) which can be used to change a certain status, parameter value etc. In LTE this can be carried out using higher layer signaling, which is considerably faster in LTE than in HSDPA.

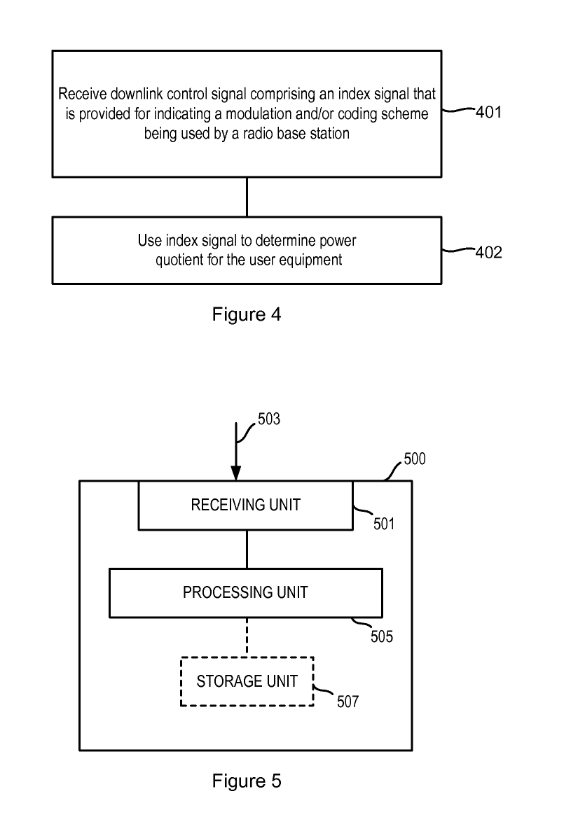

FIG. 4 shows the steps performed by a user equipment of a telecommunication system, according to an embodiment of the present invention, for determining a power quotient that is to be used by the user equipment, the power quotient providing a relationship between a reference signal (for example a dedicated pilot signal, or DeModulation Reference Symbol, DMRS) and a data signal.

In step 401 the user equipment receives a downlink control signal comprising an index signal that is provided for indicating a modulation and/or coding scheme being used by a radio base station.

The user equipment uses this index signal, step 402, to determine a power quotient that is to be used by the user equipment.

The power quotient provides information about the power content of the downlink signal, and the information provided by the determined power quotient may be used by the user equipment for many things. For example, when estimating (calculating) demodulation weights, soft values, etc., symbols can be scaled using the power of the dedicated pilot (reference) symbols (signals). The power quotient can be used for many applications depending on a particular implementation, including use in a channel estimator, whereby the (known) power of the pilots are used to scale the channel estimate to fit the data symbols.

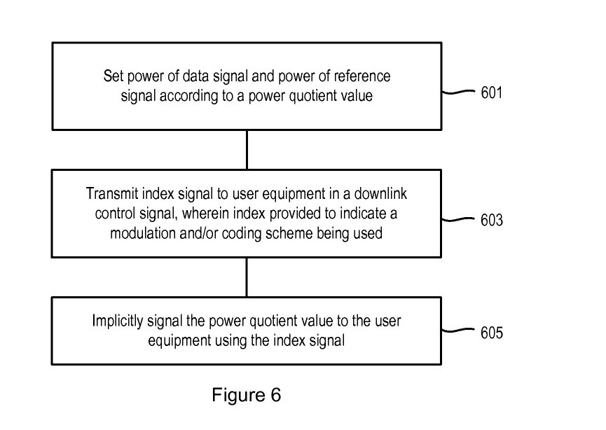

FIG. 5 shows a user equipment 500 according to an embodiment of the invention. The user equipment comprises a receiving unit 501 for receiving a downlink control signal 503 from a radio base station. The user equipment also comprises a processing unit 505. The processing unit 505 is adapted to extract an index signal contained in the downlink control signal, the index signal relating to a coding and/or modulation scheme being used by the radio base station, and to configure the user equipment according to the coding and/or modulation scheme indexed by the index signal. For example, the UE can be configured to convert the index signal into a modulation order and/or coding rate to be used in a demodulator or decoder of the UE. The processing unit 505 is further adapted to determine a power quotient using the index signal, and configure the user equipment using the determined power quotient. For example, the determined power quotient can be used during a channel estimation procedure performed by the UE.

In one embodiment the user equipment comprises a storage unit (or memory) 507 shown in dotted lines, which is configured to store a reference table for mapping an index signal with a respective power quotient. For example, the storage unit can be configured to store a table as shown in FIG. 3a or 3b, or some other form of table linked to a particular standard.

The table stored in the UE 500 can be configured such that it matches a similar table stored by the RBS, such that the UE can retrieve a power quotient from a given index signal, without having to send signaling traffic over the telecommunications system or network. The table stored in the storage unit 507 of the UE 500 can be configured, for example, during call set-up, or at some other phase of operation. Also, if needed, the table can be updated periodically such that the table stored in the UE provides an accurate mapping between index signals and power quotients, or for matching a corresponding table stored in the RBS.

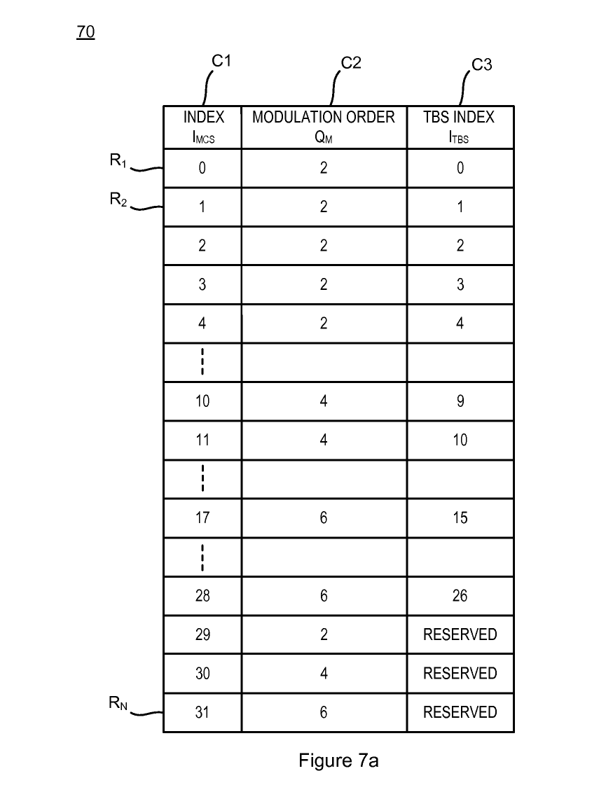

FIG. 6 shows the steps performed in a radio base station, according to an embodiment of the invention. In step 601 the radio base station sets a power of a data signal and the power of a reference signal (for example a dedicated pilot signal, or DeModulation Reference Symbol, DMRS) according to a power quotient value. In step 603 the radio base station transmits an index signal to a user equipment in a downlink control signal, wherein the index signal is provided for indicating a modulation and/or coding scheme being used by the radio base station. The radio base station implicitly signals the power quotient value to the user equipment using the index signal, step 605.

The choice of coding and modulation scheme is based on a best estimate of a RBS of the expected downlink channel quality and, typically, chosen to target a predefined error probability for the transmission. As such it represents an estimate of the expected signal to noise ratio (SNR) on the downlink channel.

When per-UE based power control is used on the downlink, the SNR on the channel is a parameter that influences the choice of power used to transmit the DMRS and/or the data. In other words, there is a close relationship between the SNR and the preferred power quotient.

Therefore, the embodiments of the present invention consist of linking the value of the power quotient between the powers of the DMRS and the downlink data to the coding and/or modulation scheme used. This is done by adding the power quotient as another entry in the modulation and coding scheme tables, for example tables already present in the standards.

For example, in existing standards such as LTE and WCDMA/HSPA, the current coding and modulation scheme is signaled for each UE in the downlink scheduling message. This is a bit-field of, typically, 5-6 bits, indicating the rate of the coding scheme (i.e., the amount of redundancy transmitted) and the modulation type used (for example QPSK, 16 QAM or 64 QAM). Therefore, according to one embodiment the bit-field (typically 5-6 bits) signaling the rate of the coding scheme and modulation type can also be used to signal the value of the power quotient.

It is noted that, strictly speaking, a dynamic power quotient is only relevant for modulation schemes that contain constellation points of different power, such as, for example, 16 QAM and 64 QAM. However, the same power quotient can nevertheless be defined for all modulation schemes of constant power (such as QPSK) since the code rate might vary between transmissions, and hence, the required DMRS-to-data power quotient.

In the HSDPA standard, the High-Speed Shared Control Channel (HS-SCCH), or the downlink control channel, contains information about the number of spreading codes, modulation order, and transport block size (TBS), among other things. From the channelization code information, a UE can calculate how many symbols the TTI contains. For example, if one slot contains 160 symbols per code at SF=16, a TTI contains 3×160=480 symbols/code. The modulation information then indicates how many bits/symbols that are transmitted, and hence, the UE can calculate how many bits that will be transmitted on the HS-PDSCH. Finally, the UE can calculate the code-rate by dividing the TBS with the total number of bits. If a multiple-input and multiple-output (MIMO) transmission is scheduled on the HS-PDSCH, the number of layers is also indicated on the HS-HCCH.

As mentioned above, different telecommunication standards will comprise different tables or index values that can be used to indicate a coding and/or modulation scheme being used, and hence used to implicitly indicate a preferred power quotient for such coding and/or modulation schemes.

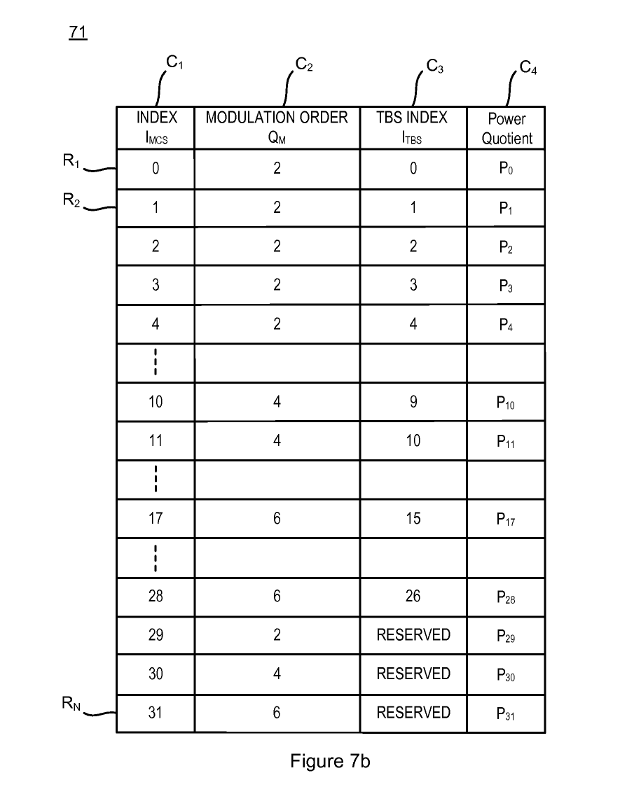

For example, in the technical specifications of the 3rd Generation Partnership Project (3GPP), the technical specification 3GPP TS 36.213 (from Release 8 onwards) includes a table 7.1.7.1-1 relating to the LTE standard. This table comprises a first column C1 comprising a list of index signals relating to a modulation and/or coding scheme (Index signal I_{MCS}), shown in rows R₁ to Rₙ, for example having 32 values. The index signals I_{MCS} are used to map or point to a modulation order, shown in column C2 of FIG. 7a (the table also comprises index signals relating to the transport block size (TBS), shown in column C3).

According to an embodiment of the invention as shown in FIG. 7b, the table of FIG. 7a is modified such that an additional column C4 is provided to indicate the power quotient to be used for each index signal I_{MCS}. As such, the index signal I_{MCS} is used to implicitly infer the power quotient being signaled by the RBS.

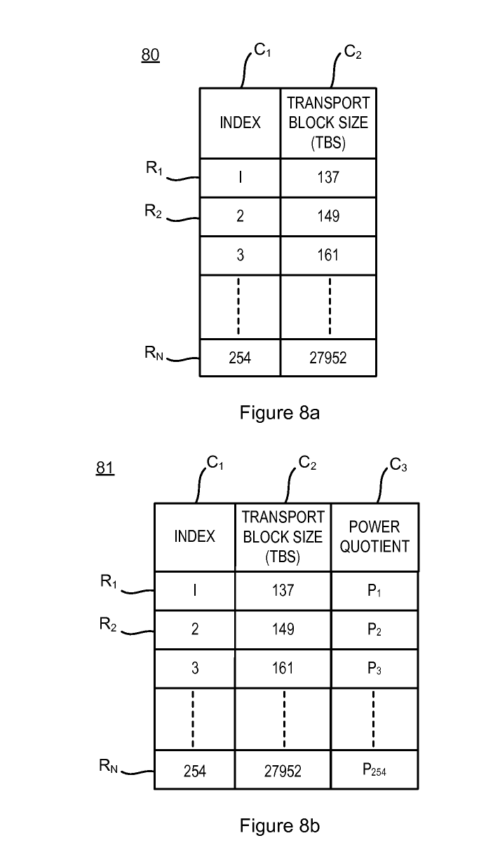

FIG. 8a shows part of a table from Annex A of technical specification 3GPP TS 25.321 from the HSDPA standard (from Release 5 onwards), which is used in conjunction with section 9.2.3.1 of 3GPP TS 25.321 (from Release 5 onwards) to work out the coding rate. The table comprises an index signal (shown in column C1) and a corresponding transport block size (TBS) shown in column C2. The table comprises a plurality of rows R₁ to Rₙ, for example 254 rows) mapping the various index values and the TBS values. The index signal is therefore used to indicate a coding scheme or coding rate being used.

According to an embodiment of the present invention, the table of FIG. 8a can be modified as shown in FIG. 8b, such that an additional column is provided for indicating the power quotient P₁ to Pₙ to be used for each respective index signal.

It can be seen from the above that the embodiments of the invention do not need to separately indicate the pilot power (i.e. the reference signal power) if the network and the UE have a common table of pilot-to-data ratios indexed by, for example, modulation, code-rate and number of MIMO layers. Such a table can be agreed by higher-layer signaling at, for example, call setup. It is noted that in an application having multi-user MIMO, several UEs can share the signaling power. This may be taken into account by having another, separate column for the power quotient, whose values are adjusted to reflect the sharing of power between multiple UEs. Alternatively, it is possible to rely on the already existing signaling of the power discrepancy, and adjust the entries in a single-user MIMO column, before the power quotient values are used for channel estimation. According to one embodiment different MIMO orders can be taken into account by providing different power quotient columns, with the RBS or network configuring which one to use.

It is also possible to have a set of tables, and the network configured with an appropriate choice of table, this choice being indicated to the terminal. For example, it is possible to have different tables for different types of channel since the time dispersion in the channel may affect the power needed for accurate channel estimation. Alternatively, multiple columns may be provided in a table, with a RBS or network configuring which column is to be used.

The embodiments of the invention have the advantage of enabling the implicit signaling of the power quotient to individual UEs. Furthermore, the embodiments of the invention enable the implicit signaling of the power quotient on a per-TTI basis, and without any additional explicit signaling needed compared to existing implementations of downlink scheduling.

Hence, the embodiments of the invention accommodate the need of power control to individual UEs, and allow a fast operation since the power quotient can be adapted for every TTI, without any additional explicit signaling.

Utilizing the already existing bit-fields for signaling of the coding and modulation scheme also makes the solution backwards compatible. As such, legacy UEs not supporting this type of power control are simply not affected by the signaling.

The step of implicitly signaling the power quotient, rather than relying on the UE having to estimate it, simplifies matters for UE manufacturers and provides better channel estimates, which ultimately improves the downlink capacity.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1-17. (canceled)

18. A method in a user equipment of a telecommunications system, for determining a power quotient that is to be used by the user equipment, wherein the power quotient provides a relationship between a reference signal and a data signal, and the method comprises:
receiving a downlink control signal from a radio base station, the downlink control signal containing an index signal that is provided for indicating a modulation and/or coding scheme being used by the radio base station; and
using the index signal to determine a power quotient that is to be used by the user equipment.

19. The method of claim 18, wherein determining the power quotient comprises retrieving the power quotient from a table that comprises a plurality of power quotients corresponding to a respective plurality of index signals.

20. The method of claim 19, wherein the table forms part of a modulation and/or coding scheme table.

21. The method of claim 20, wherein determining the power quotient comprises:
referring to a row in the modulation and/or coding scheme table that is indexed by the index signal for indicating a given coding and/or modulation scheme; and
extracting the power quotient from a further column in that row, the further column comprising the power quotient associated with the given coding and/or modulation scheme.

22. The method of claim 19, wherein the table comprises a dedicated table for mapping index signals corresponding to modulation and/or coding schemes with respective power quotients.

23. The method of claim 19, wherein the table is one among a number of different tables corresponding to different telecommunication standards, and wherein the user equipment accesses the appropriate table for the standard being used.

24. The method of claim 19, wherein the table contains a plurality of additional columns per row that is indexed by the index signal.

25. The method of claim 24, wherein each additional column contains a power quotient for a particular telecommunications standard.

26. The method of claim 25, wherein each additional column of the table contains a power quotient for a particular operating condition, including different time-dispersion channels.

27. The method of claim 19, the table is stored in the user equipment.

28. The method of claim 27, wherein the table stored on the user equipment is configured to match a corresponding table stored in the radio base station.

29. The method of claim 18, wherein the user equipment receives an index signal each transmission time interval, and wherein the step of determining the power quotient is performed during each transmission time interval.

30. The method of claim 18, wherein the reference signal is a dedicated pilot signal or a demodulation reference symbol (DMRS).

31. The method of claim 18, wherein the user equipment stores a table of modulation orders and/or coding rates representing different modulation and/or coding schemes, and wherein the table further includes different power quotients corresponding to the different modulation and/or coding schemes represented in the table, so that using the index signal to determine the power quotient comprises indexing into the table using the index signal, to thereby identify the modulation order and/or coding rate in use by the base station and to identify the corresponding power quotient.

32. A user equipment for use in a telecommunications system, wherein the user equipment comprises:
a receiving unit configured to receive a downlink control signal from a radio base station; and
a processing unit configured to:
extract an index signal contained in the downlink control signal, the index signal relating to a coding and/or modulation scheme being used by the radio base station;
configure the user equipment according to the coding and/or modulation scheme indexed by the index signal;
determine a power quotient using the index signal; and
configure the user equipment using the determined power quotient.

33. The user equipment of claim 32, wherein the user equipment further comprises a storage unit storing a table that maps index signals to power quotients.

34. A method in a radio base station of a telecommunications system, the method comprising:
setting a power of a data signal and a power of a reference signal according to a power quotient dependent upon a modulation and/or coding scheme being used by the radio base station; and
implicitly signaling the power quotient to the user equipment by transmitting an index signal to the user equipment that indicates the modulation and/or coding scheme.
